(19) United States
(12) Patent Application Publication
(10) Pub. No.: US 2023/0076613 A1
(43) Pub. Date: Mar. 9, 2023

(54) SYSTEMS AND METHODS FOR HYDROGEN ENERGY AND ENERGY AGGREGATION

(71) Applicant: Herve-David Gregoire-Mazzocco, Champs sur Tarentaine (FR)

(72) Inventor: Herve-David Gregoire-Mazzocco, Champs sur Tarentaine (FR)

(21) Appl. No.: 17/901,446

(22) Filed: Sep. 1, 2022

Related U.S. Application Data
(60) Provisional application No. 63/240,141, filed on Sep. 2, 2021.
(60) Provisional application No. 63/240,296, filed on Sep. 2, 2021.

(51) Int. Cl. H02J 3/32; H01M 16/00; C25B 1/04

(52) U.S. Cl. CPC H02J 3/32; H01M 16/003; C25B 1/04; H01M 2250/402; H02J 2203/20

(57) ABSTRACT

A hydrogen storage assembly includes an enclosure substantially encompassing an electrolyzer, a hydrogen storage system, a hydrogen fuel cell, an electrochemical energy storage module, a power conversion system, and a control system. The electrolyzer is configured to separate, via electrolysis, water into hydrogen gas that is stored in the hydrogen storage system; the hydrogen fuel cell is configured to convert the stored hydrogen gas into electrical energy and water. The electrochemical energy storage module is configured to function as an energy buffer; the power conversion system is configured to convert the produced electrical energy to a desired form. The control system is configured to to control the storage and distribution of the stored hydrogen and electrical energy in an optimized manner to achieve predefined financial and energy-use objectives.

### REFERENCE TO RELATED APPLICATION

The present application claims priority to U.S. Provisional Patent Application Ser. No. 63/240,141, entitled SYSTEMS AND METHODS FOR ENERGY AGGREGATION, filed Sep. 2, 2021 and claims priority to U.S. Provisional Patent Application Ser. No. 63/240,296, entitled SYSTEMS AND METHODS FOR HYDROGEN ENERGY STORAGE, filed Sep. 2, 2021, the entrie contects of which are hereby incorporated by reference.

### TECHNICAL FIELD

The present invention relates, generally, to energy aggregation systems and, more particularly, to intelligent hydrogen storage systems for solar photovoltaic energy and the use of a centralized network operation center and an analytics engine to aggregate electrical energy sources and participate in utility markets.

BACKGROUND

Recent years have seen a dramatic increase in the use of renewable energy sources such as solar photovoltaic energy. The U.S. Energy Information Administration (ETA), for example, projects that renewable energy's share of U.S. electricity generation will grow to about 22% by the end of 2021, with solar energy accounting for about 40% of all new electrical capacity in the U.S.

Despite the increased use of solar energy, the methods of storing and using that energy remain unsatisfactory in a number of respects. For example, solar photovoltaic energy is typically stored in a battery energy storage system, such as a set of lithium-ion batteries installed on the site. The energy capacity of such systems, however, is quite limited. For example, one popular battery system stores about 14 kWh of electricity. In the event of a power outage, and depending upon load conditions, such a battery would power a residence for less than a day. And while some researchers have proposed the use of hydrogen fuel cell technologies for energy storage, such systems typically require a source of natural gas with a bulky, expensive reformer unit to create the required hydrogen.

The increase in intermittent renewable energy systems connected to the power grid, such as solar photovoltaic energy, is having a dramatic effect on the overall behavior of the grid itself. One way to mitigate adverse effects, without engaging large grid investments, is to intelligently aggregate and manage distributed production and storage assets.

While some cloud-based aggregation engines have been developed to allow renewable energy companies to participate in utility markets, such systems are unsatisfactory in a number of respects. For example, known energy aggregation systems often rely on standard, unsecure public networks, thereby increasing cybersecurity and other risks. Furthermore, such systems are generally fragmented (rather than integrated) and are not capable of intelligently optimizing the behavior of assets to achieve optimum use and marketization. This is particularly the case with regard to utility ancillary services bidding platforms, which are experiencing increased popularity in recent years.

Accordingly, systems and methods are therefore needed to overcome these and other limitations of prior art electrical energy aggregation and storage systems.

### SUMMARY OF THE INVENTION

In accordance with various embodiments of the present invention, a hydrogen storage assembly includes an enclosure substantially encompassing an electrolyzer, a hydrogen storage system, a hydrogen fuel cell, an electrochemical energy storage module, a power conversion system, and a control system. The electrolyzer is configured to separate, via electrolysis, water into hydrogen gas that is stored in the hydrogen storage system; the hydrogen fuel cell is configured to convert the stored hydrogen gas into electrical energy and water. The electrochemical energy storage module is configured to function as an energy buffer; the power conversion system is configured to convert the produced electrical energy to a desired form. The control system is configured to to control the storage and distribution of the stored hydrogen and electrical energy in an optimized manner to achieve predefined financial and energy-use objectives.

An energy aggregation system in accordance with one embodiment includes: a plurality of network communication interfaces, each coupled to a respective hydrogen storage assembly associated with a customer, wherein each hydrogen storage assembly includes a control system; an analytics system communicatively coupled to the plurality of network communication interfaces, the analytics system configured to employ one or more machine learning models to aggregate status and energy data received from the control system; and a network operations center communicatively coupled to the analytics system.

### BRIEF DESCRIPTION OF THE DRAWING FIGURES

The present invention will hereinafter be described in conjunction with the appended drawing figures, wherein like numerals denote like elements, and:

FIG. 1 is a conceptual overview of an energy generation and storage system in accordance with one embodiment;

FIG. 2 is a conceptual block diagram of a network operations center and related components in accordance with an exemplary embodiment; and

FIG. 3 is a conceptual block diagram of a network operations center and related components in accordance with an exemplary embodiment.

### DETAILED DESCRIPTION OF PREFERRED EXEMPLARY EMBODIMENTS

The present subject matter relates to systems and methods for the hydrogen-based storage of excess energy produced, for example, by solar photovoltaic systems. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to solar energy, power distribution in a commercial or residential context, and hydrogen cells may not be described in detail herein.

The present subject matter relates to systems and methods for aggregating electrical energy (e.g., energy stored in hydrogen fuel cell assemblies) using a network operations center and associated analytics system that incorporates a machine learning engine configured to aggregate status information and data from a number of sites. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to solar energy, power distribution in a commercial or residential context, electrical power utilities, ancillary services bidding platforms, and hydrogen cells may not be described in detail herein.

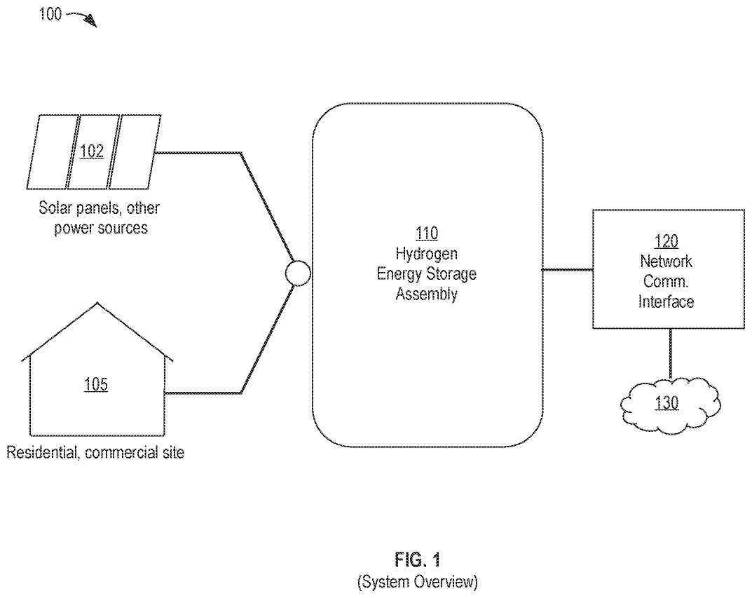

Referring now to the figures, FIG. 1 is a conceptual overview of an energy generation and storage system 100 in accordance with one embodiment, and which may be used in connection with a network operations center as described in further detail below. In general, system 100 includes a hydrogen energy storage assembly (or simply “storage assembly”) 110, which is communicatively coupled to one or more power sources 102 (e.g., photovoltaic solar panel components), the electrical system of a residential or commercial site 105 (which generally consumes, in part, power from solar panels 102 and a connected power grid), a network communication interface (or simply “interface”) 120, which provides data communication via a network 130 (e.g., a proprietary network or VPN). It will be appreciated that, in the interest of simplicity, a number of commonly known components have not been included in the figures, such as inverters, fuseboxes, meters, switches, wiring, power conditioning units, and the like.

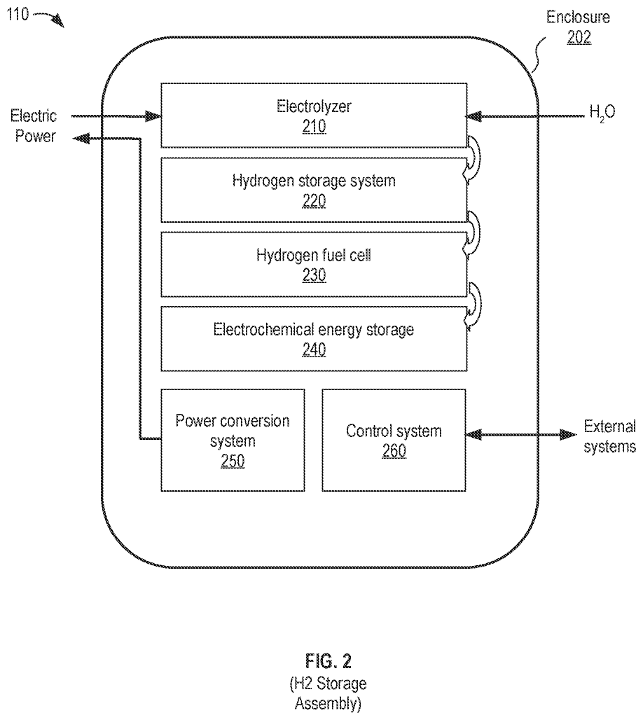

Referring now to FIG. 2, a conceptual block diagram of a hydrogen storage assembly 110 in accordance with one embodiment will now be described. As shown, storage assembly is a compact, self contained unit fitting within an enclosure 202, and includes: an electrolyzer 210, a hydrogen storage system 220, a hydrogen fuel cell 230, a battery energy storage system 240, a power conversion system 250, and a control system 260.

Electrolyzer 210 is configured to accept a water source and electrical power to separate—via electrolysis—the water into hydrogen gas (which is suitably stored via hydrogen storage system 220), and oxygen gas, which is vented or otherwise ejected for the system for further processing.

Hydrogen storage system 220 may use a variety of techniques to store hydrogen produced by electrolyzer 210. In one embodiment, a metal hydride storage device is used, thereby allowing the gas to be stored within a metal powder, which has significant safety advantages over high-pressure tank systems. Depending upon the embodiment, the system 220 may store hydrogen in the range of 2.5 kg (providing 40 kWh) to 10 kg (providing 160 kWh).

Hydrogen fuel cell 230 is configured to convert hydrogen gas (and oxygen) into electricity and water, as is known in the art. The resulting electrical energy is transferred to the electrical power conversion system 250, which converts DC to DC and DC to AC, thereby providing a simple plug-and-play interface that is easy to install in a residential or commercial environment. In this way, assembly 110 effectively acts as an extension to solar panel system 102.

Electrochemical energy storage system 240 serves as a small energy buffer that allows the system to respond quickly to transient energy needs. System 240 may be implemented using a variety of technologies, such as ultra-capacitors, LiPo or NiMH battery arrays.

Control system 260 is suitably coupled to the other components of assembly 110 (via one or more data communication buses, interconnects, or other commonly known electrical systems) and is configured to control the storage and distribution of the stored hydrogen and electrical energy in an optimized manner to achieve predefined financial and energy use objectives. For example, excess energy from solar panels 102 are preferably used to power electrolyzer 210 when control system 260 identifies an opportune time. When there is a significant demand for electrical power, control system 260 feeds hydrogen from storage system 220 to fuel cell 230 to produce energy for consumption by site 105. Control system 260 is configured to communicate with external systems and networks as shown.

Control system 260 may employ one or more machine learning or predictive analytics models to optimize energy usage, distribution, and/or storage. In this regard, the phrase “machine learning” model is used without loss of generality to refer to any result of an analysis that is designed to make some form of prediction, such as predicting the state of a response variable, clustering patients, determining association rules, and performing anomaly detection. Thus, for example, the term “machine learning” refers to models that undergo supervised, unsupervised, semi-supervised, and/or reinforcement learning. Such models may perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

Control system 260 may, for example, provide energy forecasting on the input side of the hydrogen fuel cell. To do this, the system may employ a Long Short-Term memory (LSTM) model with a gating mechanism, wherein the dataset includes parameters such as irradiance, meteorological, and real time energy consumption data. The system 260 will then predict the direct normal irradiance (DNI) from the solar panel 102. The process will include dataset description followed by data cleaning and data visualization. The system 260 may also use min-max scaler and lagged features to improve the accuracy of the baseline model.

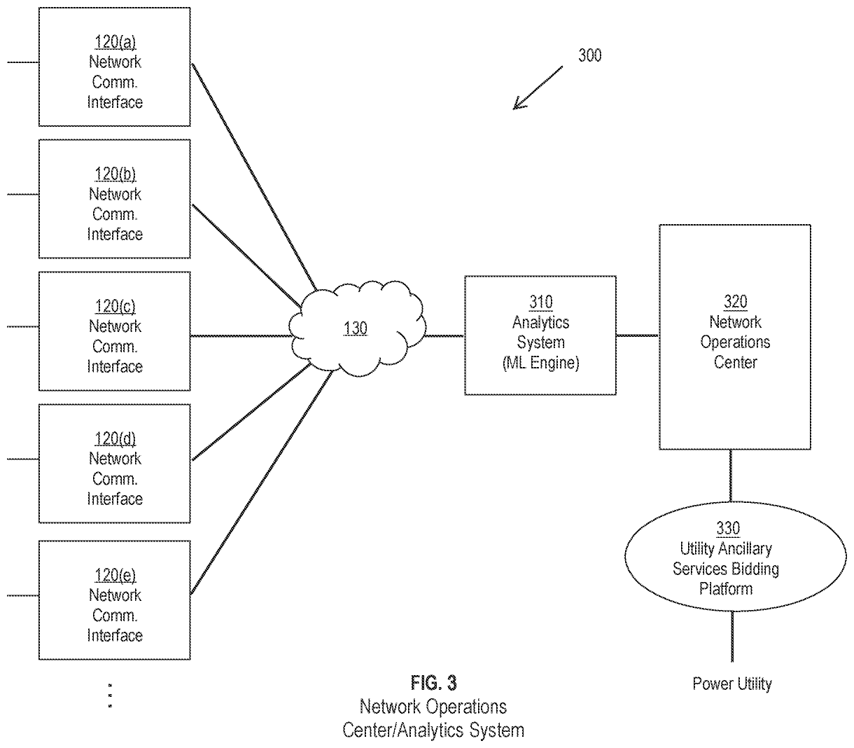

Referring now to the conceptual block diagram of FIG. 3, an aggregation system in accordance with one embodiment generally includes any number of network communication interfaces 120 (e.g., 120(a)-120(e)) corresponding to individual residential or commercial sites (as described in conjunction with FIG. 1).

Network interfaces 120 are communicatively coupled via network 130 to an analytics system 310, which includes a suitable combination of hardware and software (including one or more machine learning modules) configured to achieve the goals of this invention. Analytics system 310 is communicatively coupled to a network operations center 320, which itself is coupled to a utility ancillary services bidding platform (or simply “utility bidding platform”) 330. Interfaces 120 may be associated, for example, with residential housing in a particular subdivision or other geographical area.

Network operations center (or “NOC”) 320 provides a central site for managing the other components of the system shown in FIG. 3, including interfaces 120 and analytics system 310. Utility bidding platform 330, as is known in the art, provides a mechanism by which a power utility may obtain ancillary services from customers in a P2P energy trading community. This helps the utility balance the transmission system and matching supply and demand.

Analytics system 310 preferably employs one or more machine learning or predictive analytics models to aggregate status and energy data received from interfaces 120. In this way, analytics system 310 is configured to learn from this data to optimize its interaction with utility bidding platform 330 and to otherwise optimize participation of assets in the applicable markets (i.e., maximizing an asset's market monetization while maintaining availability to end users). In addition, the use of a proprietary network infrastructure removes the risks associated with public networks. For data aggregation, the system may use a secure, proprietary broadband mesh network for high data rates, low latency, high reliability, and redundancy.

One advantage of the present system relates to its control of the entire vertical business from home energy monitoring, flexible hydrogen-based storage, a proprietary network, cloud based analytics system 310, NOC 220, and a bidding interface to platform 330.

The phrase “machine learning” model as used in connection with analytics system 310 refers to any result of an analysis that is designed to make some form of prediction, such as predicting the state of a response variable, clustering patients, determining association rules, and performing anomaly detection. Thus, for example, the term “machine learning” refers to models that undergo supervised, unsupervised, semi-supervised, and/or reinforcement learning. Such models may perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

Any data generated and stored by the above system (e.g., analytics system 310, control system 260, and NOC 220) may be stored and handled in a secure fashion (i.e., with respect to confidentiality, integrity, and availability). For example, a variety of symmetrical and/or asymmetrical encryption schemes and standards may be employed to securely handle data at rest and in motion. Without limiting the foregoing, such encryption standards and key-exchange protocols might include Triple Data Encryption Standard (3DES), Advanced Encryption Standard (AES) (such as AES-128, 192, or 256), Rivest-Shamir-Adelman (RSA), Twofish, RC4, RC5, RC6, Transport Layer Security (TLS), Diffie-Hellman key exchange, and Secure Sockets Layer (SSL). In addition, various hashing functions may be used to address integrity concerns associated with the data.

Various systems and methods are described above in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, field-programmable gate arrays (FPGAs), Application Specific Integrated Circuits (ASICs), logic elements, look-up tables, network interfaces, or the like, which may carry out a variety of functions under the control of one or more microprocessors or other control devices either locally or in a distributed manner.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, individually or in any combination, including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A hydrogen storage assembly comprising:
an enclosure substantially encompassing an electrolyzer, a hydrogen storage system, a hydrogen fuel cell, an electrochemical energy storage module, a power conversion system, and a control system;
wherein the electrolyzer is configured to separate, via electrolysis, water into hydrogen gas that is stored in the hydrogen storage system; the hydrogen fuel cell is configured to convert the stored hydrogen gas into electrical energy and water; the electrochemical energy storage module is configured to function as an energy buffer; the power conversion system is configured to convert the produced electrical energy to a desired form; and
the control system is configured to to control the storage and distribution of the stored hydrogen and electrical energy in an optimized manner to achieve predefined financial and energy-use objectives.

2. The hydrogen storage assembly of claim 1, wherein the control system provides energy forecasting by using a Long Short-Term memory (LSTM) model with a gating mechanism, wherein the dataset includes at least one of irradiance data, meteorological data, and real time energy consumption data.

3. The hydrogen storage assembly of claim 2, wherein the control system predicts the direct normal irradiance (DNI) from a solar panel.

4. The hydrogen storage assembly of claim 3, wherein the control system uses at least one of a min-max scaler and lagged features to improve the accuracy of a model.

5. The hydrogen storage assembly of claim 1, further including an analytics system communicatively coupled to the control system, the analytics system configured to employ one or more machine learning models to aggregate status and energy data received from the control system.

6. An energy aggregation system comprising:
a plurality of network communication interfaces, each coupled to a respective hydrogen storage assembly associated with a customer, wherein each hydrogen storage assembly includes a control system;
an analytics system communicatively coupled to the plurality of network communication interfaces, the analytics system configured to employ one or more machine learning models to aggregate status and energy data received from the control system; and
a network operations center communicatively coupled to the analytics system.

7. The energy aggregation system of claim 6, further including a utility bidding platform communicatively coupled to the network operations center and a power utility.

8. The energy aggregation system of claim 7, wherein each control system provides energy forecasting by using a Long Short-Term memory (LSTM) model with a gating mechanism, wherein the dataset includes at least one of irradiance data, meteorological data, and real time energy consumption data.

9. The energy aggregation system of claim 8, wherein the control system predicts the direct normal irradiance (DNI) from a solar panel.

10. The energy aggregation system of claim 7, wherein the utility bidding platform allows the power utility to obtain ancillary services from the customers in a P2P energy trading community to thereby manage supply and demand of electrical energy.

11. An energy aggregation system comprising:
a plurality of network communication interfaces, each coupled to a respective hydrogen storage assembly associated with a customer, wherein each hydrogen storage assembly includes a control system;
an analytics system communicatively coupled to the plurality of network communication interfaces, the analytics system configured to employ one or more machine learning models to aggregate status and energy data received from the control system, wherein each control system provides energy forecasting based on at least one of irradiance data, meteorological data, and real time energy consumption data.
a network operations center communicatively coupled to the analytics system; and
a utility bidding platform communicatively coupled to the network operations center and a power utility, the utility bidding platform configured such that the power utility obtains ancillary services from the customers in a P2P energy trading community to thereby manage supply and demand of electrical energy.

12. The energy aggregation system of claim 11, wherein at least one of the hydrogen storage assemblies includes:
an enclosure substantially encompassing an electrolyzer, a hydrogen storage system, a hydrogen fuel cell, an electrochemical energy storage module, a power conversion system, and a control system;
wherein the electrolyzer is configured to separate, via electrolysis, water into hydrogen gas that is stored in the hydrogen storage system; the hydrogen fuel cell is configured to convert the stored hydrogen gas into electrical energy and water; the electrochemical energy storage module is configured to function as an energy buffer; the power conversion system is configured to convert the produced electrical energy to a desired form.

13. The energy aggregation system of claim 12, wherein the hydrogen storage system includes at least one of an ultra-capacitor, a LiPo battery array, and a NiMH battery array.

14. The energy aggregation system of claim 12, wherein the hydrogen storage system is a metal hydride storage device.

15. The energy aggregation system of claim 12, wherein the hydrogen storage system stores hydrogen in the range of 2.5 kg to 10 kg.

16. The energy aggregation system of claim 12, wherein the electrolyzer is operated using excess energy from solar panels in accordance with scheduling determined by the control system.
